(19) United States
(12) Patent Application Publication
(10) Pub. No.: US 2021/0134176 A1
(43) Pub. Date: May 6, 2021

(54) METHODS AND SYSTEMS OF FACILITATING MANAGEMENT OF AN AVIATION SERVICE FOR A STUDENT PILOT

(71) Applicant: Joseph Trimmer, New Orleans, LA (US)

(72) Inventor: Joseph Trimmer, New Orleans, LA (US)

(21) Appl. No.: 17/086,100

(22) Filed: Oct. 30, 2020

Related U.S. Application Data
(60) Provisional application No. 62/927,891, filed on Oct. 30, 2019.

(51) Int. Cl. G09B 9/08; G09B 9/16; G09B 9/30; B64D 43/00; G08G 5/00; G06F 16/9035

(52) U.S. Cl. CPC G09B 9/085; G09B 9/16; G06F 16/9035; B64D 43/00; G08G 5/0021; G09B 9/30

(57) ABSTRACT

Disclosed herein is a method of facilitating management of an aviation service for a student pilot, in accordance with some embodiments. Accordingly, the method may include a step of receiving at least one student pilot data from at least one student pilot device. Further, the method may include a step of retrieving at least one regulation data from a database. Further, the method may include a step of analyzing the at least one student pilot data based on the at least one regulation data. Further, the method may include a step of identifying at least one of an instructor and an aircraft owner based on the analyzing. Further, the method may include a step of generating at least one notification based on the identifying. Further, the method may include a step of transmitting the at least one notification to the at least one student pilot device.

The current application claims a priority to the U.S. Provisional Patent application Ser. No. 62/927,891 filed on Oct. 30, 2019.

### TECHNICAL FIELD

Generally, the present disclosure relates to the field of data processing. More specifically, the present disclosure relates to methods and systems for facilitating management of an aviation service for a student pilot.

### BACKGROUND

Existing techniques for facilitating management of an aviation service for a student pilot are deficient with regard to several aspects. For instance, current technologies do not address market inefficiency in the aviation industry. Further, the current technologies do not assist the student pilots in finding the certified flight instructors. Furthermore, the current technologies do not reduce pilot shortage. Further, the current technologies do not assist the student pilots in verification of documents. Further, the current technologies do not facilitate verification of certifications associated with the student pilots, certified flight instructors, and aircraft owners that may be required to fly.

Therefore, there is a need for improved methods and systems for facilitating management of an aviation service for a student pilot that may overcome one or more of the above-mentioned problems and/or limitations.

### BRIEF SUMMARY

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is a method of facilitating management of an aviation service for a student pilot, in accordance with some embodiments. Accordingly, the method may include a step of receiving, using a communication device, at least one student pilot data from at least one student pilot device associated with at least one student pilot. Further, the method may include a step of retrieving, using a storage device, at least one regulation data from a database associated with the aviation service. Further, the method may include a step of analyzing, using a processing device, the at least one student pilot data based on the at least one regulation data. Further, the method may include a step of identifying, using the processing device, at least one of an instructor and an aircraft owner based on the analyzing. Further, the method may include a step of generating, using the processing device, at least one notification based on the identifying. Further, the method may include a step of transmitting, using the communication device, the at least one notification to the at least one student pilot device.

Further disclosed herein is a system for facilitating management of an aviation service for a student pilot, in accordance with some embodiments. Accordingly, the system may include a communication device configured for receiving at least one student pilot data from at least one student pilot device associated with at least one student pilot. Further, the communication device may be configured for transmitting at least one notification to the at least one student pilot device. Further, the system may include a processing device configured for analyzing the at least one student pilot data based on at least one regulation data. Further, the processing device may be configured for identifying at least one of an instructor and an aircraft owner based on the analyzing. Further, the processing device may be configured for generating the at least one notification based on the identifying. Further, the system may include a storage device configured for retrieving the at least one regulation data from a database associated with the aviation service.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform consistent with various embodiments of the present disclosure.

FIG. 2 is a block diagram of a system of facilitating management of an aviation service for a student pilot, in accordance with some embodiments

FIG. 3 is a flowchart of a method of facilitating management of an aviation service for a student pilot, in accordance with some embodiments.

FIG. 4 is a flowchart of a method of facilitating generation of a result indication corresponding to an instructor, in accordance with some embodiments

FIG. 5 is a flowchart of a method of facilitating generation of a result indication corresponding to an aircraft owner, in accordance with some embodiments.

FIG. 6 is a flowchart of a method of facilitating generation of an eligibility condition corresponding to at least one of an instructor and an aircraft owner, in accordance with some embodiments.

FIG. 7 is a flowchart of a method of facilitating generation of availability status data based on an instructor data, in accordance with some embodiments.

FIG. 8 is a flowchart of a method of facilitating generation of availability status data based on an aircraft owner data, in accordance with some embodiments.

FIG. 9 is a flowchart of a method of facilitating storing a service data associated with a student pilot, in accordance with some embodiments.

FIG. 10 is a flowchart of a method of facilitating receiving a feedback associated with the aviation service, in accordance with some embodiments.

FIG. 11 is a flowchart of a method of facilitating generation of an alert based on analyzing sensor data, in accordance with some embodiments.

FIG. 12 is a flowchart of a method of facilitating generation of score based on predetermined aircraft criteria, in accordance with some embodiments.

FIG. 13 is a flowchart of a method of facilitating interaction of student pilots with certified flight instructors and aircraft owners, in accordance with some embodiments.

FIG. 14 is a schematic of a system to illustrate the transmission of data among a plurality of stakeholders associated with Part 61 software platform, in accordance with some embodiments.

FIG. 15 is a block diagram of a computing device for implementing the methods disclosed herein, in accordance with some embodiments.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of methods and systems for facilitating management of an aviation service for a student pilot, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor, and at least one actuator. Examples of the one or more client devices and/or the server computer may include, a desktop computer, a laptop computer, a tablet computer, a personal digital assistant, a portable electronic device, a wearable computer, a smartphone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice-based interface, gesture-based interface etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third-party database, public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role-based access control, and so on.

Further, one or more steps of the method disclosed herein may be initiated, maintained, controlled and/or terminated based on a control input received from one or more devices operated by one or more users such as, for example, but not limited to, an end-user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human-readable secret data (e.g. username, password, passphrase, PIN, secret question, secret answer etc.) and/or possession of a machine-readable secret data (e.g. encryption key, decryption key, bar codes, etc.) and/or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human-readable data from an input device such as, for example, a keyboard, a keypad, a touch-screen, a microphone, a camera and so on. Likewise, the one or more steps may include receiving, using the communication device, the one or more embodied characteristics from one or more biometric sensors.

Further, one or more steps of the method may be automatically initiated, maintained and/or terminated based on one or more predefined conditions. In an instance, the one or more predefined conditions may be based on one or more contextual variables.

In general, the one or more contextual variables may represent a condition relevant to the performance of the one or more steps of the method. The one or more contextual variables may include, for example, but are not limited to, location, time, identity of a user associated with a device (e.g. the server computer, a client device, etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

### Overview

The present disclosure may describe methods and systems to facilitate the interaction of student pilots with certified flight instructors and aircraft owners. Further, the system may include a software platform Part 61. Further, the present disclosure relates to Federal Aviation Administration (FAA) Part 61 regulations. Further, the software platform Part 61 may be published on all distribution channels such as Apple™ App Store, Google™ Play, and others. Further, the software platform Part 61 will address a current market inefficiency in the aviation industry. Airplane owners mostly do not fly their planes regularly. Further, this results in airplanes tied down or hangared at airports most of the time. Further, the airplanes tied down or hangared at airports may pose a liability to the owner's finances. Further, owning airplanes may be expensive and many owners may love to ease that burden by renting the airplanes. Further, the Certified Flight Instructors (CFI) may have an option of joining a school that may force them to sign a non-compete agreement or find student pilots independently and train them. If the CFI does not own a plane that makes this path a challenge. Further, the student pilots may choose to train with a flight school. Further, the flight schools generally may prefer that the student pilot rents their planes for training. Further, if the student pilot buys his own plane training is much lower. The problem for students that may buy a plane to train on is finding qualified flight instructors to train them. Further, the software platform Part 61 fixes the market inefficiency by connecting student pilots with certified flight instructors and airplanes from owners that may want to monetize their planes. Further, the software platform Part 61 may profit from making these connections. Further, the software platform Part 61 may collect a portion of the training fee, a portion of the rent and will charge student pilots a membership fee and monthly dues. Further, the software platform Part 61 may also help ease the pilot shortage by making it much easier to On-ramp new student pilots by connecting them with airplanes and certified flight instructors. Further, the software platform Part 61 may verify that all members have current valid necessary certifications that may be needed to fly. Further, the software platform Part 61 may also make things easier for student pilots by connecting or interfacing with the appropriate FAA website and helping the new student pilot apply for a student certificate. Further, the software platform Part 61 may also help them schedule/book a doctor's appointment with an FAA-approved doctor to get the required medical screening. Further, all documents may be loaded into the software platform Part 61 for review and verification. Further, the software platform Part 61 may guide new student pilots through the process and check on them for progress through notifications until all legal documents required by the FAA have been submitted. This also applies to required documents for aircraft so the aircraft can join. Further, the software platform Part 61 may connect airplanes that may belong to private owners with people like student pilots, certified flight instructors and private pilots that may need an airplane to travel or learn new skills.

Further, the software platform Part 61 may be connected to the FAA websites. Further, the connection may make things easier for new student pilots when it's confusing to start. Further, the software platform Part 61 may talk to the FAA for the student pilots.

Further, the disclosed system may describe a software platform. Further, the software platform may allow a student pilot to enter their information and then just must accept, agree, etc. As soon as the student has the temp certificate, they can receive training from a Certified Flight Instructor (CFI).

Further, the software platform may make onboarding students as easy as possible. After the student applies and receives a temp certificate, he should be able to book time with a CFI and rent a plane through the software platform. Further, the disclosed system may include a student flight log book that may be updated every week, student pilot certificate or temp certificate, medical certificate, id, payment methods, signed contract with the software platform.

Further, the certified flight instructor should be able to easily sign up and find students to train. He/she makes money by training students. Further, the disclosed system may connect students to the CFI. Further, documents required (or need) by the software platform may include a pilot license, Commercial license, CFI license, endorsements, medical class C and above, flight logbooks, ID, signed contract with the software platform. Further, the students should be able to leave star reviews with no comments.

Further, the airplane owner that wants to monetize their airplane by renting should find people to rent their plane on the software platform. Further, documents required (or need) by the software platform may include an airplane Pilot's Operating Handbook (POH), airplane registration, airplane latest weight and balance document, airplane logbooks all of them, airworthiness certificate, commercial insurance that allows for instruction and rental, ID, signed contract with the software platform. Further, if the owner is a pilot, documents required may include a pilot license, ID, Medical, and endorsements.

Further, the admin user at first will be on the back end turning users on or off after document review, background check, etc. The goal is to automate as much of this as possible. Admin heavy is ok for MVP.

Further, the software platform may need to determine how to start and end the session.

1. Start Button, GPS ping
2. Card authorization
3. End Button, GPS ping
4. Charge card

### 5. Leave Review

On principle, the software platform may need as much info as possible to make good business decisions.

Further, the disclosed system may include a two-tiered pricing model. Further, the two-tiered pricing model may include a membership cost for pilots and students that may be $299 per month recurring or $3000 yearly recurring. Further, the membership cost associated with the airplane owner, CFI may be $199 per month recurring or $2000 yearly recurring. Further, the membership may be canceled anytime with no penalty. Further, the members may pay 1%-50% less per training hr and for rental hrs. Admin sets % discount. Further, the software platform keeps 5%, 95% paid to owners and CFIs. Further, the nonmembers may pay market prices set by plane Owners and CFI's. Further, the software platform keeps 20%, 80% is disbursed.

Further, the disclosed system may include a method of facilitating generation of expenses data based on a service parameter. Further, the method may include determining, using a processing device, at least one service parameter associated with the at least one of the aviation service, wherein the aviation service is availed by the at least one student pilot student. Further, the method may include analyzing, using the processing device, at least one service parameter based on a pre-determined charge card. Further, the method may include generating, using the processing device, an expense data based on the analyzing of the service parameter. Further, the method may include transmitting, using a communication device, the expense data to the at least one student pilot device. Further, the method may include receiving, using the communication device, at least one review from the at least one student pilot. Further, the method may include storing, using a storage device, the at least one review.

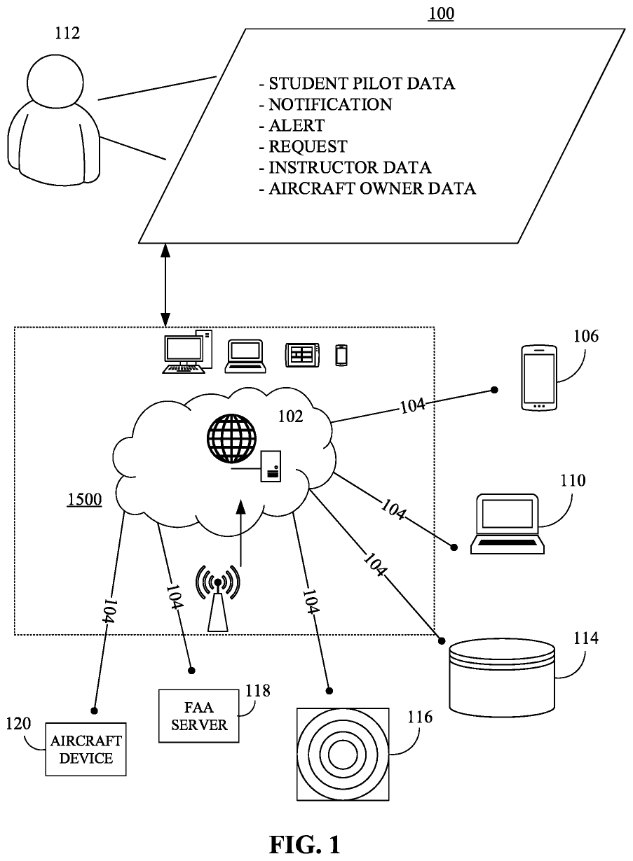

Referring now to figures, FIG. 1 is an illustration of an online platform 100 consistent with various embodiments of the present disclosure. By way of non-limiting example, the online platform 100 to facilitate management of an aviation service for a student pilot may be hosted on a centralized server 102, such as, for example, a cloud computing service. The centralized server 102 may communicate with other network entities, such as, for example, a mobile device 106 (such as a smartphone, a laptop, a tablet computer, etc.), other electronic devices 110 (such as desktop computers, server computers, etc.), databases 114, sensors 116, FAA server 118, and aircraft device 120 over a communication network 104, such as, but not limited to, the Internet. Further, users of the online platform 100 may include relevant parties such as, but not limited to, end-users, administrators, service providers, service consumers and so on. Accordingly, in some instances, electronic devices operated by the one or more relevant parties may be in communication with the platform. Further, the sensors 116 may include a plurality of sensors. Further, the plurality of sensors may include aircraft sensors, physiological sensors, etc. Further, the aircraft sensors may be associated with sensors installed in the aircraft. Further, the physiological sensors may facilitate determination of physiological parameters associated with the student pilots, certified flight instructors, etc. Further, the physiological parameters may include heartbeat rate, blood pulse rate, respiration rate, etc.

A user 112, such as the one or more relevant parties, may access online platform 100 through a web-based software application or browser. The web-based software application may be embodied as, for example, but not be limited to, a website, a web application, a desktop application, and a mobile application compatible with a computing device 1500.

Further, the Federal Aviation Administration (FAA) server 118 may include data associated with the end-users, but not limited to, student pilots, certified flight instructors and aircraft owners. Further, the data may include aircraft data and student physiological data. Further, the data may be transmitted to the online platform 100. Further, the aircraft data may include information associated with an aircraft that may include aircraft model, engine specification, etc. Further, the student physiological data may include information associated with the physiological parameters of the student while flying the aircraft.

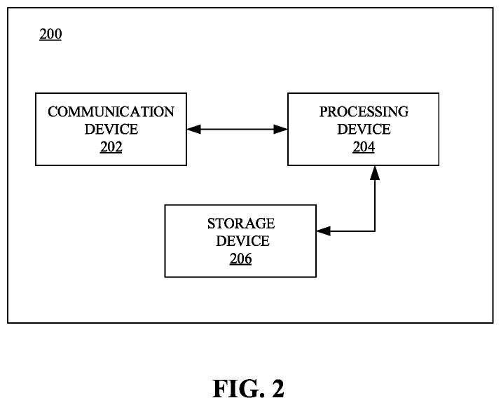

FIG. 2 is a block diagram of a system 200 of facilitating management of an aviation service for a student pilot, in accordance with some embodiments. Accordingly, the system 200 may include a communication device 202, a processing device 204, and a storage device 206.

Further, the communication device 202 may be configured for receiving at least one student pilot data from at least one student pilot device associated with at least one student pilot. Further, the at least one student pilot data may include a profile data and a service request data. Further, the profile data may include profile details of the at least one student pilot. Further, the profile details may include name, address, contact number, qualification, certification, etc. Further, the service request data may be associated with the selection of the aviation service. Further, the service request data may include a location, a date, a time, an aircraft specification, etc. for the aviation service. Further, the aviation service may include an instructor service and an aircraft service. Further, the at least one student pilot device may include a smartphone, a mobile, a tablet, a laptop, a personal computer, and so on. Further, the communication device 202 may be configured for transmitting at least one notification to the at least one student pilot device. Further, the at least one notification may be associated with the at least one of the identified instructor and identified aircraft owner.

Further, the processing device 204 may be configured for analyzing the at least one student pilot data based on at least one regulation data. Further, the at least one regulation may be associated with rules that may govern operation of the aviation service. Further, the processing device 204 may be configured for identifying at least one of an instructor and an aircraft owner based on the analyzing. Further, the instructor may include an individual, an organization, and an institution that may want to provide the aviation service. Further, the aircraft owner may include an individual, an organization, and an institution that may want to provide the aviation service. Further, the processing device 204 may be configured for generating the at least one notification based on the identifying.

Further, the storage device 206 may be configured for retrieving the at least one regulation data from a database associated with the aviation service.

In further embodiments, the communication device 202 may be configured for transmitting at least one request to an instructor device based on the identifying. the communication device 202 may be configured for receiving at least one instructor data from the instructor device. Further, the at least one instructor data may include a profile data. Further, the profile data may include a name, an address, a contact number, a qualification certification, etc. Further, the processing device 204 may be configured for analyzing the at least one instructor data based on at least one instructor regulation data. Further, the processing device 204 may be configured for generating at least one notification based on the analyzing of the at least one instructor data. Further, the processing device 204 may be configured for generating a result indication corresponding to the instructor based on the analyzing of the at least one instructor data. Further, the storage device 206 may be configured for retrieving the at least one instructor regulation data from the database associated with the aviation service. Further, the at least one regulation data may include the at least one instructor regulation data.

In further embodiments, the communication device 202 may be configured for transmitting at least one request to an aircraft owner device based on the identifying. Further, the communication device 202 may be configured for receiving at least one aircraft owner data from the aircraft owner device based on the identifying. Further, the at least one aircraft owner data may include a profile data and an air vehicle data. Further, the profile data may include a name, an address, a contact number, a qualification certification, etc. Further, the air vehicle data be associated with an aircraft, such as, but not limited to, an airplane, a helicopter, etc. Further, the air vehicle data may include quality certification, safety certification, model number, engine specifications, distance traveled, etc. Further, the processing device 204 may be configured for analyzing the at least one aircraft owner data based on at least one aircraft owner regulation data. Further, the processing device 204 may be configured for generating at least one notification based on the analyzing of the at least one aircraft owner data. Further, the processing device 204 may be configured for generating a result indication corresponding to the aircraft owner based on the analyzing of the at least one aircraft owner data. Further, the storage device 206 may be configured for retrieving the at least one aircraft owner regulation data from the database associated with the aviation service. Further, the at least one regulation data may include the at least one aircraft owner regulation data.

In further embodiments, the communication device 202 may be configured for transmitting at least one eligibility indication to at least one of the instructor device and the aircraft owner device. Further, the processing device 204 may be configured for generating the at least one eligibility indication corresponding to at least of the instructor and the aircraft owner based on the analyzing of at least one of the at least one instructor data and the at least one aircraft owner data. Further, the at least one eligibility indication may be associated with an authorization (or permission) that may be associated with provision of the aviation service by the at least one of the instructor and the aircraft owner.

In further embodiments, the communication device 202 may be configured for transmitting at least one request to the instructor device based on the identifying. Further, the communication device 202 may be configured for receiving the at least one instructor data from the instructor device. Further, the communication device 202 may be configured for transmitting at least one availability status data to the at least one student pilot device. Further, the processing device 204 may be configured for analyzing the at least one instructor data. Further, the processing device 204 may be configured for generating the at least one availability status data corresponding to the aviation service based on the analyzing of the at least one instructor data. Further, the at least one availability status data may include time, date, duration, location, etc. that may facilitate provision of the aviation service to the at least one student pilot by the instructor.

In further embodiments, the communication device 202 may be configured for transmitting at least one request to the aircraft owner device based on the identifying. Further, the communication device 202 may be configured for receiving the at least one aircraft owner data from the aircraft owner device. Further, the communication device 202 may be configured for transmitting at least one availability status data to the at least one student pilot device. Further, the processing device 204 configured for analyzing the at least one aircraft owner data. Further, the processing device 204 configured for generating the at least one availability status data corresponding to the aviation service based on the analyzing of the at least one aircraft owner data. Further, the at least one availability status data may include time, date, duration, location, etc. associated with the aircraft that may facilitate provision of the aviation service to the at least one student pilot by the aircraft owner.

Further, in some embodiments, at least one of the instructor device and the aircraft owner device may include at least one service sensor. Further, the communication device 202 may be configured for receiving at least one service data from the at least one service sensor. Further, the at least one service sensor may be configured for generating the at least one service data. Further, the at least one service data may be associated with a student logbook associated with the at least one student pilot. Further, the student logbook may include the profile data, the air vehicle data, duration of aviation service attended by the at least one student pilot. Further, the communication device 202 may be configured for transmitting the at least one service data to the at least one of the at least one student pilot device, the instructor device, and a regulatory authority device. Further, the regulatory authority device may be associated with a regulatory authority. Further, the storage device 206 may be configured for storing the at least one service data in a database. Further, the storage device 206 may be communicatively coupled with the at least one service sensor.

In further embodiments, the communication device 202 may be configured for receiving at least one feedback from the at least one student pilot device. Further, the at least one feedback may be associated with the aviation service. Further, the at least one feedback may include a measure of appreciation by the at least one student pilot. Further, the measure of appreciation may be based on score, ratings that may be provided by the at least one student pilot. Further, the communication device 202 may be configured for transmitting the at least one feedback to at least one of the at least one student pilot device, the instructor device, and the aircraft owner device. Further, the storage device 206 may be configured for storing the at least one feedback.

In further embodiments, the communication device 202 may be configured for receiving at least one sensor data from the at least one of the instructor device and the aircraft owner device. Further, at least one of the instructor device and the aircraft owner device may include at least one student sensor. Further, the at least one student sensor may be configured to generate the at least one sensor data. Further, the at least one sensor data may be associated with the at least one student pilot and the instructor. Further, the at least one sensor data may be associated with behavior of the at least one student pilot and the instructor. Further, the behavior of the at least one student pilot and the instructor may facilitate assessment of the aviation service associated with the at least one student pilot and the instructor.

Further, the communication device 202 may be configured for transmitting, using the communication device 202, at least one alert to at least one of the at least one student pilot device, the instructor device, and the regulatory authority device. Further, the processing device 204 may be configured for analyzing the at least one sensor data based on the at least one regulation data. Further, the processing device 204 may be configured for generating the at least one alert based on the analyzing of the at least one sensor data. Further, the at least one alert may facilitate assessment of the aviation service associated with the at least one student pilot and the instructor. Further, the assessment of the aviation service may include a measure of appreciation that may be associated with the at least one student pilot and the instructor.

Further, in some embodiments, at least one aircraft device 120 may be disposed on an aircraft. Further, the communication device 202 may be configured for receiving at least one aircraft data from the at least one aircraft device 120. Further, the at least one aircraft device 120 may be configured to generate the at least one aircraft data. Further, each aircraft device of the at least one aircraft device 120 may be associated with each aircraft of at least one aircraft. Further, the aircraft data be associated with an aircraft, such as, but not limited to, an airplane, a helicopter, etc. Further, the aircraft data may include quality certification, safety certification, model number, engine specifications, distance travelled, etc. Further, the communication device 202 may be configured for transmitting each predetermined aircraft criterion and a score associated with the each aircraft of the at least one aircraft to the at least one student pilot device. Further, the processing device 204 may be configured for analyzing each aircraft data of the at least one aircraft data corresponding to the each aircraft based on at least one predetermined aircraft criterion. Further, the processing device 204 may be configured for generating the score corresponding to the each predetermined aircraft criterion of the at least one predetermined aircraft criterion based on the analyzing of the each aircraft data. Further, the at least one predetermined aircraft criterion may be associated with the aircraft. Further, the predetermined aircraft include a distance, engine specification, quality certification, safety certification, etc.

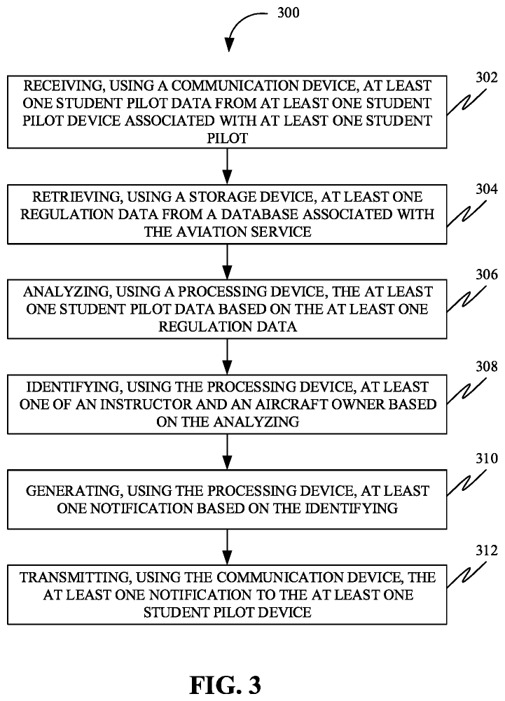

FIG. 3 is a flowchart of a method 300 of facilitating management of an aviation service for a student pilot, in accordance with some embodiments. Accordingly, at 302, the method 300 may include a step of receiving, using a communication device (such as the communication device 202), at least one student pilot data from at least one student pilot device associated with at least one student pilot. Further, the at least one student pilot data may include a profile data and a service request data. Further, the profile data may include profile details of the at least one student pilot. Further, the profile details may include name, address, contact number, qualification, certification, etc. Further, the service request data may be associated with the selection of the aviation service. Further, the service request data may include a location, a date, a time, an aircraft specification, etc. for the aviation service. Further, the aviation service may include an instructor service and an aircraft service. Further, the at least one student pilot device may include a smartphone, a mobile, a tablet, a laptop, a personal computer, and so on.

Further, at 304, the method 300 may include a step of retrieving, using a storage device (such as the storage device 206), at least one regulation data from a database associated with the aviation service. Further, the at least one regulation may be associated with rules that may govern operation of the aviation service.

Further, at 306, the method 300 may include a step of analyzing, using a processing device (such as the processing device 204), the at least one student pilot data based on the at least one regulation data.

Further, at 308, the method 300 may include a step of identifying, using the processing device, at least one of an instructor and an aircraft owner based on the analyzing. Further, the instructor may include an individual, an organization, and an institution that may want to provide the aviation service. Further, the aircraft owner may include an individual, an organization, and an institution that may want to provide the aviation service.

Further, at 310, the method 300 may include a step of generating, using the processing device, at least one notification based on the identifying.

Further, at 312, the method 300 may include a step of transmitting, using the communication device, the at least one notification to the at least one student pilot device.

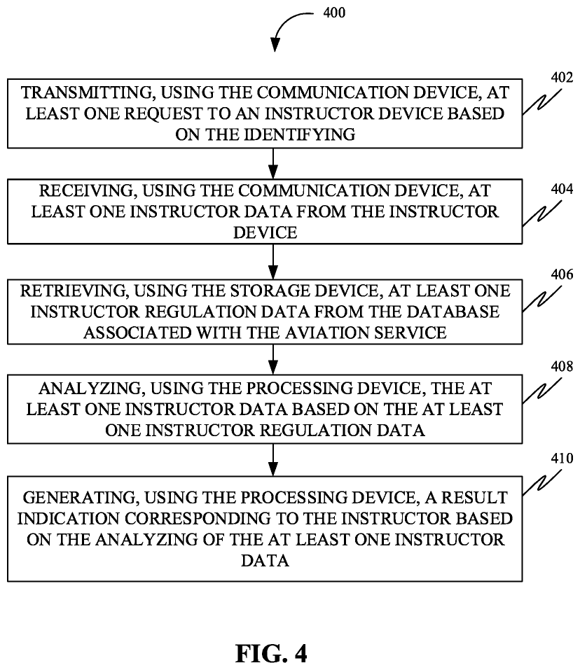

FIG. 4 is a flowchart of a method 400 of facilitating generation of a result indication corresponding to an instructor, in accordance with some embodiments. Accordingly, at 402, the method 400 may include a step of transmitting, using the communication device, at least one request to an instructor device based on the identifying.

Further, at 404, the method 400 may include a step of receiving, using the communication device, at least one instructor data from the instructor device. Further, the at least one instructor data may include a profile data. Further, the profile data may include a name, an address, a contact number, a qualification certification, etc.

Further, at 406, the method 400 may include a step of retrieving, using the storage device, at least one instructor regulation data from the database associated with the aviation service. Further, the at least one regulation data may include the at least one instructor regulation data.

Further, at 408, the method 400 may include a step of analyzing, using the processing device, the at least one instructor data based on the at least one instructor regulation data. Further, the processing device may be configured for generating at least one notification based on the analyzing of the at least one instructor data.

Further, at 410, the method 400 may include a step of generating, using the processing device, a result indication corresponding to the instructor based on the analyzing of the at least one instructor data.

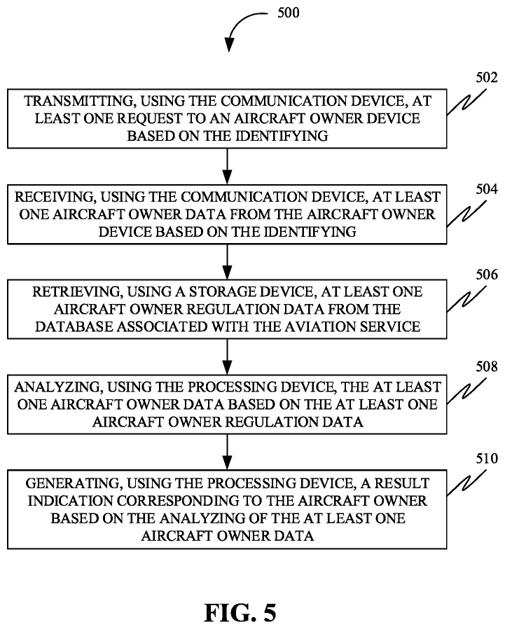

FIG. 5 is a flowchart of a method 500 of facilitating generation of a result indication corresponding to an aircraft owner, in accordance with some embodiments. Accordingly, at 502, the method 500 may include a step of transmitting, using the communication device, at least one request to an aircraft owner device based on the identifying.

Further, at 504, the method 500 may include a step of receiving, using the communication device, at least one aircraft owner data from the aircraft owner device based on the identifying. Further, the at least one aircraft owner data may include a profile data and an air vehicle data. Further, the profile data may include a name, an address, a contact number, a qualification certification, etc. Further, the air vehicle data be associated with an aircraft, such as, but not limited to, an airplane, a helicopter, etc. Further, the air vehicle data may include quality certification, safety certification, model number, engine specifications, distance traveled, etc.

Further, at 506, the method 500 may include a step of retrieving, using a storage device, at least one aircraft owner regulation data from the database associated with the aviation service. Further, the at least one regulation data may include the at least one aircraft owner regulation data.

Further, at 508, the method 500 may include a step of analyzing, using the processing device, the at least one aircraft owner data based on the at least one aircraft owner regulation data. Further, the processing device may be configured for generating at least one notification based on the analyzing of the at least one aircraft owner data.

Further, at 510, the method 500 may include a step of generating, using the processing device, a result indication corresponding to the aircraft owner based on the analyzing of the at least one aircraft owner data.

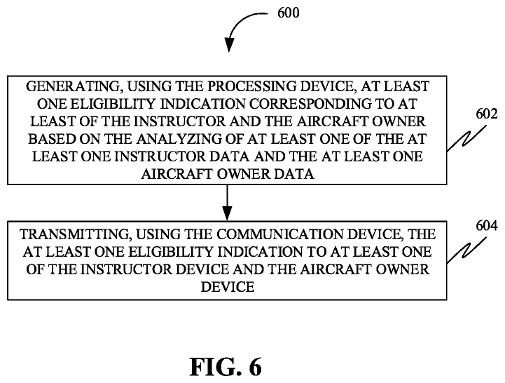

FIG. 6 is a flowchart of a method 600 of facilitating generation of an eligibility condition corresponding to at least one of an instructor and an aircraft owner, in accordance with some embodiments. Accordingly, at 602, the method 600 may include a step of generating, using the processing device, at least one eligibility indication corresponding to at least of the instructor and the aircraft owner based on the analyzing of at least one of the at least one instructor data and the at least one aircraft owner data. Further, the at least one eligibility indication may be associated with an authorization (or permission) that may be associated with provision of the aviation service by the at least one of the instructor and the aircraft owner.

Further, at 604, the method 600 may include a step of transmitting, using the communication device, the at least one eligibility indication to at least one of the instructor device and the aircraft owner device.

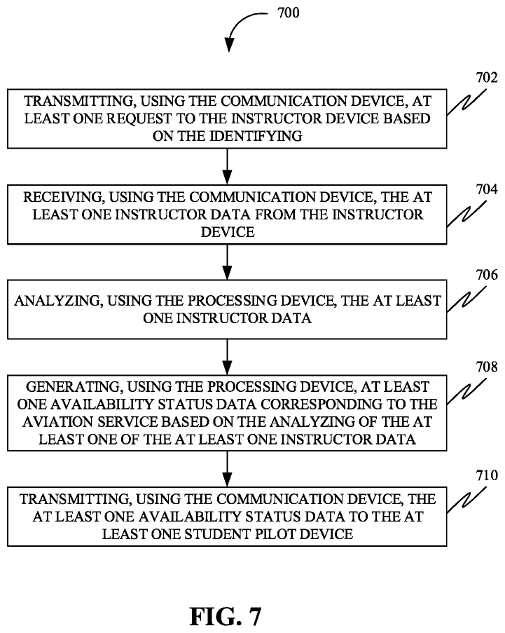

FIG. 7 is a flowchart of a method 700 of facilitating generation of availability status data based on an instructor data, in accordance with some embodiments.

Accordingly, at 702, the method 700 may include a step of transmitting, using the communication device, at least one request to the instructor device based on the identifying.

Further, at 704, the method 700 may include a step of receiving, using the communication device, the at least one instructor data from the instructor device.

Further, at 706, the method 700 may include a step of analyzing, using the processing device, the at least one instructor data.

Further, at 708, the method 700 may include a step of generating, using the processing device, at least one availability status data corresponding to the aviation service based on the analyzing of the at least one instructor data. Further, the at least one availability status data may include time, date, duration, location, etc. that may facilitate provision of the aviation service to the at least one student pilot by the instructor.

Further, at 710, the method 700 may include a step of transmitting, using the communication device, the at least one availability status data to the at least one student pilot device.

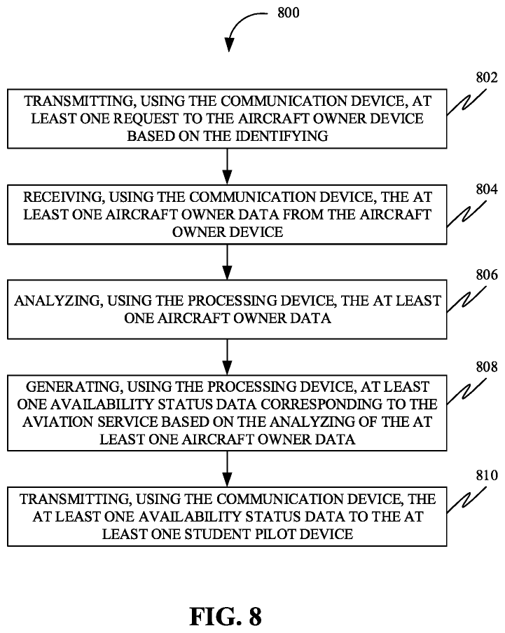

FIG. 8 is a flowchart of a method 800 of facilitating generation of availability status data based on an aircraft owner data, in accordance with some embodiments. Accordingly, at 802, the method 800 may include a step of transmitting, using the communication device, at least one request to the aircraft owner device based on the identifying.

Further, at 804, the method 800 may include a step of receiving, using the communication device, the at least one aircraft owner data from the aircraft owner device;

Further, at 806, the method 800 may include a step of analyzing, using the processing device, the at least one aircraft owner data.

Further, at 808, the method 800 may include a step of generating, using the processing device, at least one availability status data corresponding to the aviation service based on the analyzing of the at least one aircraft owner data. Further, the at least one availability status data may include time, date, duration, location, etc. associated with the aircraft that may facilitate provision of the aviation service to the at least one student pilot by the aircraft owner.

Further, at 810, the method 800 may include a step of transmitting, using the communication device, the at least one availability status data to the at least one student pilot device.

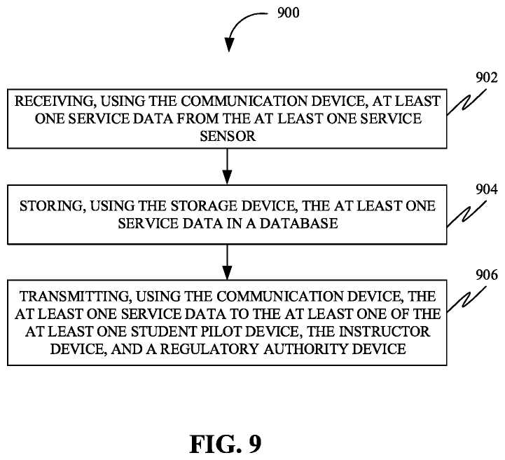

FIG. 9 is a flowchart of a method 900 of facilitating storing a service data associated with a student pilot, in accordance with some embodiments. Accordingly, at least one of the instructor device and the aircraft owner device may include at least one service sensor. Further, at 902, the method 900 may include a step of receiving, using the communication device, at least one service data from the at least one service sensor. Further, the at least one service sensor may be configured for generating the at least one service data. Further, the at least one service data may be associated with a student logbook associated with the at least one student pilot. Further, the student logbook may include the profile data, the air vehicle data, duration of aviation service attended by the at least one student pilot.

Further, at 904, the method 900 may include a step of storing, using the storage device, the at least one service data in a database. Further, the storage device may be communicatively coupled with the at least one service sensor.

Further, at 906, the method 900 may include a step of transmitting, using the communication device, the at least one service data to the at least one of the at least one student pilot device, the instructor device, and a regulatory authority device. Further, the regulatory authority device may be associated with a regulatory authority.

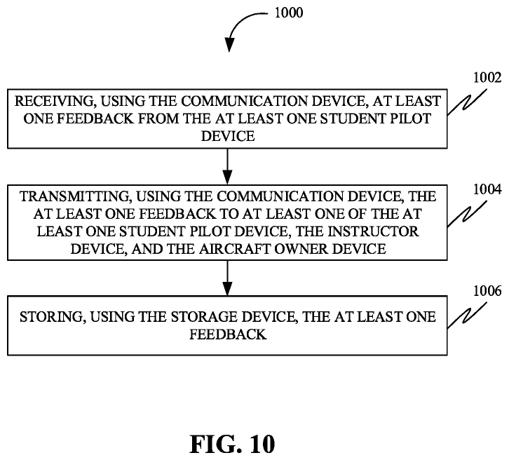

FIG. 10 is a flowchart of a method 1000 of facilitating receiving a feedback associated with the aviation service, in accordance with some embodiments. Accordingly, at 1002, the method 1000 may include a step of receiving, using the communication device, at least one feedback from the at least one student pilot device. Further, the at least one feedback may be associated with the aviation service. Further, the at least one feedback may include a measure of appreciation by the at least one student pilot. Further, the measure of appreciation may be based on score, ratings that may be provided by the at least one student pilot.

Further, at 1004, the method 1000 may include a step of transmitting, using the communication device, the at least one feedback to at least one of the at least one student pilot device, the instructor device, and the aircraft owner device.

Further, at 1006, the method 1000 may include a step of storing, using the storage device, the at least one feedback.

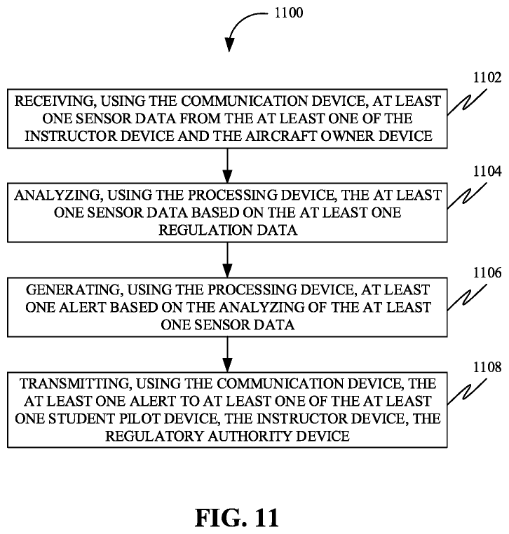

FIG. 11 is a flowchart of a method 1100 of facilitating generation of an alert based on analyzing sensor data, in accordance with some embodiments. Accordingly, at 1102, the method 1100 may include a step of receiving, using the communication device, at least one sensor data from the at least one of the instructor device and the aircraft owner device. Further, the at least one of the instructor device and the aircraft owner device may include at least one student sensor. Further, the at least one student sensor may be configured to generate the at least one sensor data. Further, the at least one sensor data may be associated with the at least one student pilot and the instructor. Further, the at least one sensor data may be associated with behavior of the at least one student pilot and the instructor.

Further, at 1104, the method 1100 may include a step of analyzing, using the processing device, the at least one sensor data based on the at least one regulation data. Further, the behavior of the at least one student pilot and the instructor may facilitate assessment of the aviation service associated with the at least one student pilot and the instructor.

Further, at 1106, the method 1100 may include a step of receiving generating, using the processing device, at least one alert based on the analyzing of the at least one sensor data.

Further, at 1108, the method 1100 may include a step of receiving transmitting, using the communication device, the at least one alert to at least one of the at least one student pilot device, the instructor device, the regulatory authority device. Further, the at least one alert may facilitate assessment of the aviation service associated with the at least one student pilot and the instructor. Further, the assessment of the aviation service may include a measure of appreciation that may be associated with the at least one student pilot and the instructor.

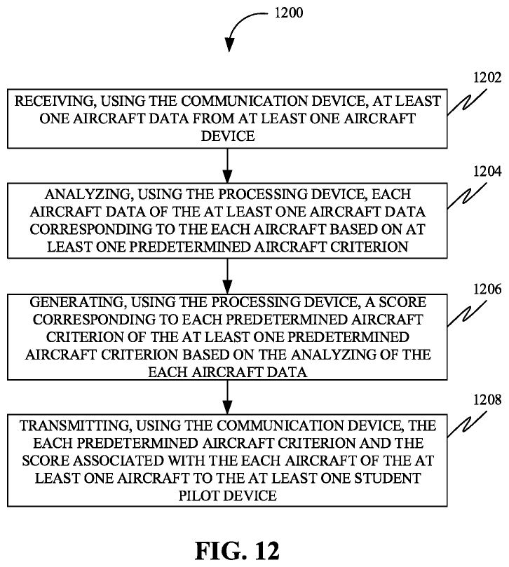

FIG. 12 is a flowchart of a method 1200 of facilitating generation of score based on predetermined aircraft criteria, in accordance with some embodiments. Accordingly, at least one aircraft device (at least one aircraft device 120) may be disposed on an aircraft. Further, at 1202, the method 1200 may include a step of receiving, using the communication device, at least one aircraft data from at least one aircraft device. Further, the at least one aircraft device may be configured to generate the at least one aircraft data. Further, each aircraft device of the at least one aircraft device may be associated with each aircraft of at least one aircraft. Further, the aircraft data be associated with an aircraft, such as, but not limited to, an airplane, a helicopter, etc. Further, the aircraft data may include quality certification, safety certification, model number, engine specifications, distance travelled, etc.

Further, at 1204, the method 1200 may include a step of analyzing, using the processing device, each aircraft data of the at least one aircraft data corresponding to the each aircraft based on at least one predetermined aircraft criterion. Further, the at least one predetermined aircraft criterion may be associated with the aircraft. Further, the predetermined aircraft include a distance, engine specification, quality certification, safety certification, etc.

Further, at 1206, the method 1200 may include a step of generating, using the processing device, a score corresponding to each predetermined aircraft criterion of the at least one predetermined aircraft criterion based on the analyzing of the each aircraft data.

Further, at 1208, the method 1200 may include a step of transmitting, using the communication device, the each predetermined aircraft criterion and the score associated with the each aircraft of the at least one aircraft to the at least one student pilot device.

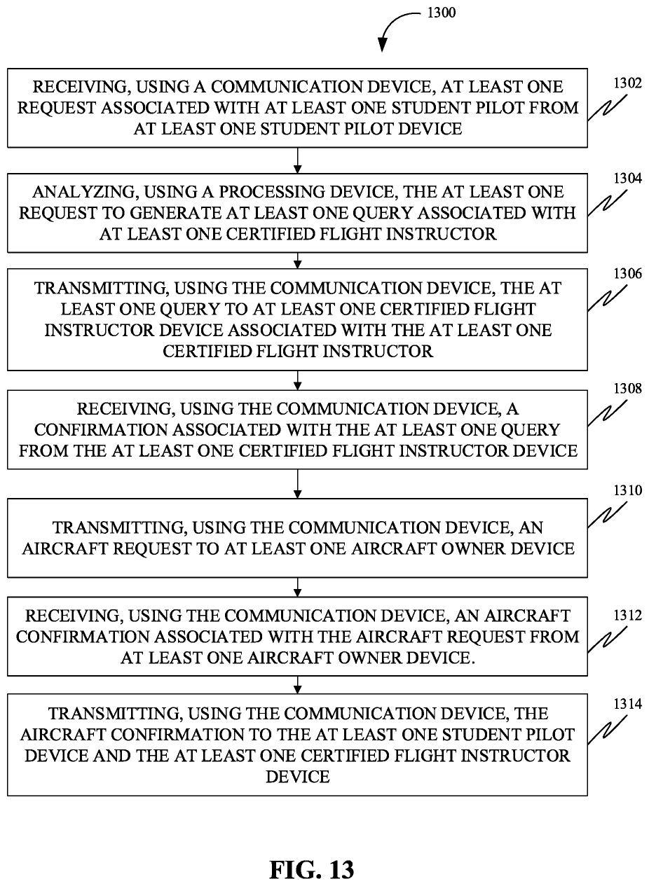

FIG. 13 is a flowchart of a method 1300 of facilitating interaction of student pilots with certified flight instructors and aircraft owners, in accordance with some embodiments. Accordingly, at 1302, the method 1300 may include a step of receiving, using a communication device, at least one request associated with at least one student pilot from at least one student pilot device. Further, the at least one request may facilitate selection of at least one second user. Further, the at least one second user may be an individual, an institution, and an organization that may be selected by the at least one student pilot. Further, the at least one student pilot may include an individual, an institution, and an organization that may want to schedule a training session. Further, the training session may refer to a training class associated with flying of an aircraft. Further, the at least one student pilot device may include a smartphone, a tablet, a laptop, a personal computer, and so on.

Further, at 1304, the method 1300 may include a step of analyzing, using a processing device, the at least one request to generate at least one query associated with at least one certified flight instructor. Further, the at least one request may be analyzed to determine parameters associated with the class session. Further, the parameters may include duration of a training class, location of the training class, location of the training class, etc. further, the at least one query may be associated with the at least one certified flight instructor. Further, the certified flight instructor may include an individual, an institution, and an organization that may want to provide training class to the at least one student pilot.

Further, at 1306, the method 1300 may include a step of transmitting, using the communication device, the at least one query to at least one certified flight instructor device associated with the at least one certified flight instructor. Further, the at least one certified flight instructor device may include a smartphone, a tablet, a laptop, a personal computer and so on.

Further, at 1308, the method 1300 may include a step of receiving, using the communication device, a confirmation associated with the at least one query from the at least one certified flight instructor device. Further, the confirmation may include a response from the at least one certified flight instructor. Further, the response may include a positive response and a negative response. Further, the positive response may refer to the acceptance of the query. Further, the negative may refer to rejection of the query.

Further, at 1310, the method 1300 may include a step of transmitting, using the communication device, an aircraft request to at least one aircraft owner device. Further, the aircraft request may be associated with the availability of an aircraft. Further, the aircraft request may include a plurality of details associated with availability of the aircraft. Further, the plurality of details may include model of aircraft, duration of the training class, location of training class, and so on. Further, the at least one aircraft owner device may be associated with at least one aircraft owner. Further, the aircraft owner may be an individual, an institution, and an organization that may own at least one aircraft. Further, the at least one aircraft owner device may include a smartphone, a tablet, a laptop, a personal computer, and so on.

Further, at 1312, the method 1300 may include a step of receiving, using the communication device, an aircraft confirmation associated with the aircraft request from at least one aircraft owner device. Further, the aircraft confirmation may include a response and a plurality of aircraft details that may be provided by the at least one aircraft owner to the at least one student pilot. Further, the plurality of details may include model of aircraft, price of the training session, duration of the training class, location of training class, and so on. Further, the response may include a positive response and a negative response. Further, the positive response may refer to the acceptance of the aircraft request. Further, the negative may refer to the rejection of the aircraft query.

Further, at 1314, the method 1300 may include a step of transmitting, using the communication device, the aircraft confirmation to the at least one student pilot device and the at least one certified flight instructor device.

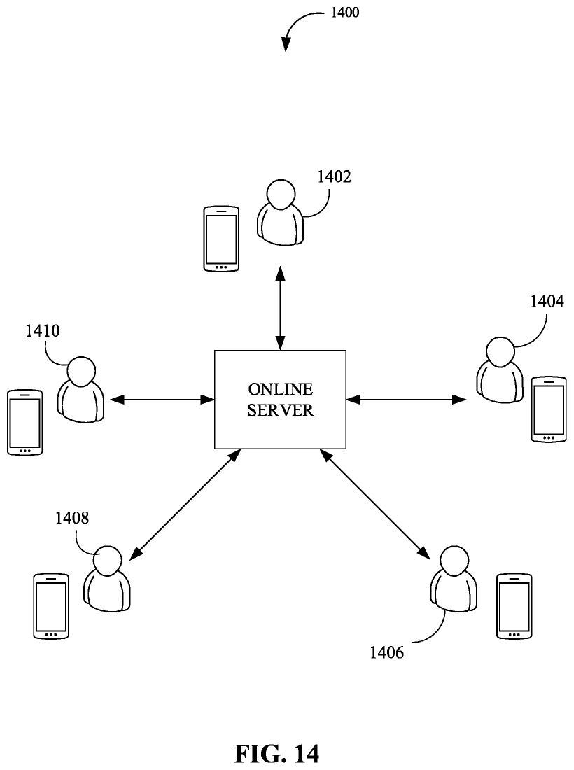

FIG. 14 is a schematic of a system 1400 to illustrate the transmission of data among a plurality of stakeholders associated with Part 61 software platform, in accordance with some embodiments. Further, the system 1400 may include a plurality of stakeholders associated with the Part 61 software platform. Further, the Part 61 software platform may operate within the guardrails of Part 61 of Federal Aviation Regulations (FAR). Further, the plurality of stakeholders may include private pilots 1402, aircraft owners 1404, certified flight instructors 1406, student pilots 1408, and administrators 1410. Further, upon signing up for the Part 61 software platform by a stakeholder of the plurality of stakeholders, verification of the stakeholder may be facilitated by the Part 61 software platform. Further, the verification may be may done upon uploading of plurality of documents associated with the stakeholder. Further, the plurality of documents may be authorized (or authenticated) by the Federal Aviation Administration (FAA). Further, the private pilots 1402 may view a list of available aircraft that may be submitted by the at least one aircraft owner for use on the part. Further, the private pilots 1402 may need to submit/upload a private pilot license, a medical certificate, and so on for verification. Further, the verification may ensure the qualification of the private pilots 1402 for the aircraft that the private pilot may want to fly. Further, the aircraft that may be available to rent on the app for the private pilots 1402 may match the qualification of the private pilots 1402.

Further, the airplane owners may be able to make their aircraft available to private pilots 1402 and student pilots 1408 with a Certified Flight Instructor (CFI) 1406 or a student pilot that may be authorized to fly alone. Further, the aircraft owner may set the hourly rate. Further, the Part 61 software platform may display the aircraft as available. Further, aircraft maintenance and insurance may meet commercial requirements such as commercial insurance, 100 hr inspections, and appropriate oil changes. Further, the aircraft owners 1404 may submit POH, Airworthiness certificate, registration insurance, maintenance logbooks, and weight and balance document. Further, the Part 61 software platform may collect a percentage of the rental rate for making the connection.

Further, the certified flight instructors 1406 may be able to rent aircraft from airplane owners to train student pilots 1408. Further, the certified flight instructors 1406 may need to submit all appropriate documentation that may verify the certified flight instructors 1406 as authorized by the FAA. Further, the certified flight instructors 1406 may choose/charge a training fee. Further, the Part 61 software platform may collect a small fee for making the connection.

Further, the Part 61 software platform may guide student pilots 1408. Further, to sign up, the student pilot may submit a student pilot license, a temp student pilot license and a medical. Further, upon non availability of an endorsement document by a certified flight instructor and a medical certificate, the student pilots 1408 may not be able to fly solo. Further, the Part 61 software platform may help the student pilots 1408 to navigate to appropriate locations of the FAA website to get the temporary certificate and find the FAA doctor for the medical. Further, the Part 61 software platform may automate signup process and steps on the FAA website. Further, the Part 61 software platform may take the information the student pilot submits at the beginning and auto-populate as much as possible on the FAA website. Further, the video https://youtu.be/u2IXnkhBsbQ may show how to register for a student pilot certificate. Further, the website is https://iacra.faa.gov. Further, the student pilots 1408 may begin to fly with the certified flight instructors 1406, upon receiving of the temp student pilot certificate. Further, the student pilots 1408 may pay for aircraft rental and certified flight instructor fees. Further, the Part 61 software platform may collect a fee from the training and from the rental.

Further, the administrator may manage all the users, booking and payments on the Part 61 software platform. Further, the administrator may review all submitted documentation and approve or deny the users.

Further, the private pilots 1402, the student pilots 1408, and the certified flight instructors 1406 may require to fly with a company certified flight instructor to get a go/no go from an experienced certified flight instructor before flying for the first time on the Part 61 software platform for extra safety.

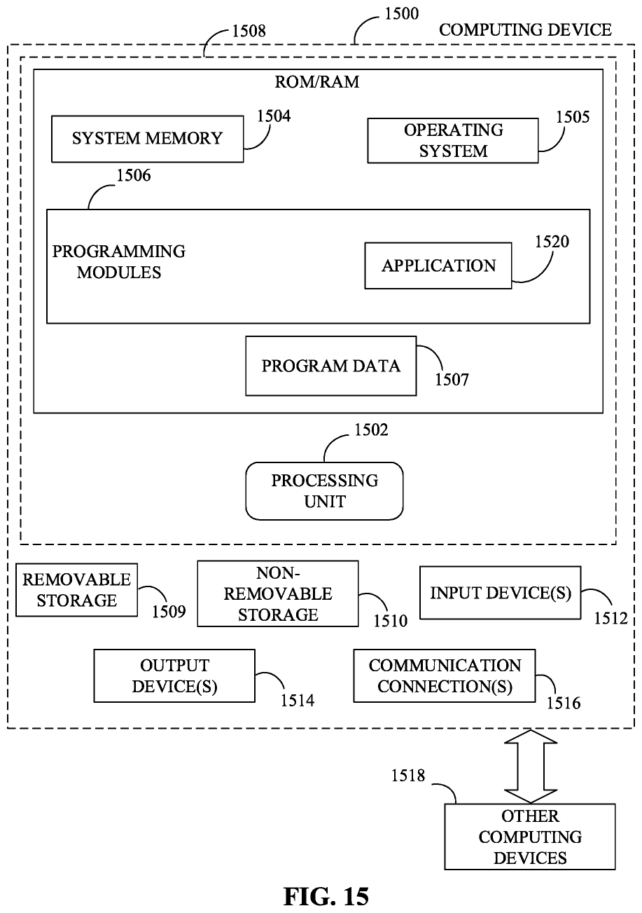

With reference to FIG. 15, a system consistent with an embodiment of the disclosure may include a computing device or cloud service, such as computing device 1500. In a basic configuration, computing device 1500 may include at least one processing unit 1502 and a system memory 1504. Depending on the configuration and type of computing device, system memory 1504 may comprise, but is not limited to, volatile (e.g. random-access memory (RAM)), non-volatile (e.g. read-only memory (ROM)), flash memory, or any combination. System memory 1504 may include operating system 1505, one or more programming modules 1506, and may include a program data 1507. Operating system 1505, for example, may be suitable for controlling computing device 1500's operation. In one embodiment, programming modules 1506 may include image-processing module, machine learning module. Furthermore, embodiments of the disclosure may be practiced in conjunction with a graphics library, other operating systems, or any other application program and is not limited to any particular application or system. This basic configuration is illustrated in FIG. 15 by those components within a dashed line 1508.

Computing device 1500 may have additional features or functionality. For example, computing device 1500 may also include additional data storage devices (removable and/or non-removable) such as, for example, magnetic disks, optical disks, or tape. Such additional storage is illustrated in FIG. 15 by a removable storage 1509 and a non-removable storage 1510. Computer storage media may include volatile and non-volatile, removable and non-removable media implemented in any method or technology for storage of information, such as computer-readable instructions, data structures, program modules, or other data. System memory 1504, removable storage 1509, and non-removable storage 1510 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 1500. Any such computer storage media may be part of device 1500. Computing device 1500 may also have input device(s) 1512 such as a keyboard, a mouse, a pen, a sound input device, a touch input device, a location sensor, a camera, a biometric sensor, etc. Output device(s) 1514 such as a display, speakers, a printer, etc. may also be included. The aforementioned devices are examples and others may be used.

Computing device 1500 may also contain a communication connection 1516 that may allow device 1500 to communicate with other computing devices 1518, such as over a network in a distributed computing environment, for example, an intranet or the Internet. Communication connection 1516 is one example of communication media. Communication media may typically be embodied by computer-readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer-readable media as used herein may include both storage media and communication media.

As stated above, a number of program modules and data files may be stored in system memory 1504, including operating system 1505. While executing on processing unit 1502, programming modules 1506 (e.g., application 1520 such as a media player) may perform processes including, for example, one or more stages of methods, algorithms, systems, applications, servers, databases as described above. The aforementioned process is an example, and processing unit 1502 may perform other processes.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general-purpose graphics processor-based systems, multiprocessor systems, microprocessor-based or programmable consumer electronics, application-specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer-readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example, but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may, in fact, be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid-state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the present disclosure has been explained in relation to its preferred embodiment, it is to be understood that many other possible modifications and variations can be made without departing from the spirit and scope of the disclosure.

The following is claimed:

1. A method of facilitating management of an aviation service for a student pilot, the method comprising:
receiving, using a communication device, at least one student pilot data from at least one student pilot device associated with at least one student pilot;
retrieving, using a storage device, at least one regulation data from a database associated with the aviation service;
analyzing, using a processing device, the at least one student pilot data based on the at least one regulation data;
identifying, using the processing device, at least one of an instructor and an aircraft owner based on the analyzing;
generating, using the processing device, at least one notification based on the identifying; and
transmitting, using the communication device, the at least one notification to the at least one student pilot device.

2. The method of claim 1 further comprising:
transmitting, using the communication device, at least one request to an instructor device based on the identifying;
receiving, using the communication device, at least one instructor data from the instructor device;
retrieving, using the storage device, at least one instructor regulation data from the database associated with the aviation service, wherein the at least one regulation data comprises the at least one instructor regulation data;
analyzing, using the processing device, the at least one instructor data based on the at least one instructor regulation data, wherein the processing device is configured for generating at least one notification based on the analyzing of the at least one instructor data; and
generating, using the processing device, a result indication corresponding to the instructor based on the analyzing of the at least one instructor data.

3. The method of claim 1 further comprising:
transmitting, using the communication device, at least one request to an aircraft owner device based on the identifying;
receiving, using the communication device, at least one aircraft owner data from the aircraft owner device based on the identifying;
retrieving, using a storage device, at least one aircraft owner regulation data from the database associated with the aviation service, wherein the at least one regulation data comprises the at least one aircraft owner regulation data;
analyzing, using the processing device, the at least one aircraft owner data based on the at least one aircraft owner regulation data, wherein the processing device is configured for generating at least one notification based on the analyzing of the at least one aircraft owner data; and
generating, using the processing device, a result indication corresponding to the aircraft owner based on the analyzing of the at least one aircraft owner data.

4. The method of claim 1 further comprising:
generating, using the processing device, at least one eligibility indication corresponding to at least of the instructor and the aircraft owner based on the analyzing of at least one of the at least one instructor data and the at least one aircraft owner data; and
transmitting, using the communication device, the at least one eligibility indication to at least one of the instructor device and the aircraft owner device.

5. The method of claim 1 further comprising:
transmitting, using the communication device, at least one request to the instructor device based on the identifying;
receiving, using the communication device, the at least one instructor data from the instructor device;
analyzing, using the processing device, the at least one instructor data;
generating, using the processing device, at least one availability status data corresponding to the aviation service based on the analyzing of the at least one instructor data; and
transmitting, using the communication device, the at least one availability status data to the at least one student pilot device.

6. The method of claim 1 further comprising:
transmitting, using the communication device, at least one request to the aircraft owner device based on the identifying;
receiving, using the communication device, the at least one aircraft owner data from the aircraft owner device;
analyzing, using the processing device, the at least one aircraft owner data;
generating, using the processing device, at least one availability status data corresponding to the aviation service based on the analyzing of the at least one aircraft owner data; and
transmitting, using the communication device, the at least one availability status data to the at least one student pilot device.

7. The method of claim 1, wherein at least one of the instructor device and the aircraft owner device comprises at least one service sensor, wherein the method further comprising:
receiving, using the communication device, at least one service data from the at least one service sensor, wherein the at least one service sensor is configured for generating the at least one service data;
storing, using the storage device, the at least one service data in a database, wherein the storage device is communicatively coupled with the at least one service sensor; and
transmitting, using the communication device, the at least one service data to the at least one of the at least one student pilot device, the instructor device, and a regulatory authority device, wherein the regulatory authority device may be associated with a regulatory authority.

8. The method of claim 1 further comprising:
receiving, using the communication device, at least one feedback from the at least one student pilot device, wherein the at least one feedback is associated with the aviation service;
transmitting, using the communication device, the at least one feedback to at least one of the at least one student pilot device, the instructor device, and the aircraft owner device; and
storing, using the storage device, the at least one feedback.

9. The method of claim 1 further comprising:
receiving, using the communication device, at least one sensor data from the at least one of the instructor device and the aircraft owner device, wherein the at least one of the instructor device and the aircraft owner device comprises at least one student sensor, wherein the at least one student sensor is configured to generate the at least one sensor data, wherein the at least one sensor data is associated with the at least one student pilot and the instructor;
analyzing, using the processing device, the at least one sensor data based on the at least one regulation data;
generating, using the processing device, at least one alert based on the analyzing of the at least one sensor data; and
transmitting, using the communication device, the at least one alert to at least one of the at least one student pilot device, the instructor device, the regulatory authority device.

10. The method of claim 1, wherein at least one aircraft device is disposed on an aircraft, wherein the method further comprising:
receiving, using the communication device, at least one aircraft data from at least one aircraft device, wherein the at least one aircraft device is configured to generate the at least one aircraft data, wherein each aircraft device of the at least one aircraft device is associated with each aircraft of at least one aircraft;
analyzing, using the processing device, each aircraft data of the at least one aircraft data corresponding to the each aircraft based on at least one predetermined aircraft criterion;
generating, using the processing device, a score corresponding to each predetermined aircraft criterion of the at least one predetermined aircraft criterion based on the analyzing of the each aircraft data; and
transmitting, using the communication device, the each predetermined aircraft criterion and the score associated with the each aircraft of the at least one aircraft to the at least one student pilot device.

11. A system of facilitating management of an aviation service for a student pilot, the system comprising:
a communication device configured for:
receiving at least one student pilot data from at least one student pilot device associated with at least one student pilot; and
transmitting at least one notification to the at least one student pilot device;
a processing device configured for:
analyzing the at least one student pilot data based on at least one regulation data;
identifying at least one of an instructor and an aircraft owner based on the analyzing; and
generating the at least one notification based on the identifying; and
a storage device configured for retrieving the at least one regulation data from a database associated with the aviation service.

12. The system of claim 11 further comprising:
the communication device configured for:
transmitting at least one request to an instructor device based on the identifying; and
receiving at least one instructor data from the instructor device;
the processing device configured for:
analyzing the at least one instructor data based on at least one instructor regulation data, wherein the processing device is configured for generating at least one notification based on the analyzing of the at least one instructor data; and
generating a result indication corresponding to the instructor based on the analyzing of the at least one instructor data; and
the storage device configured for retrieving the at least one instructor regulation data from the database associated with the aviation service, wherein the at least one regulation data comprises the at least one instructor regulation data.

13. The method of claim 11 further comprising:
the communication device configured for:
transmitting at least one request to an aircraft owner device based on the identifying; and
receiving at least one aircraft owner data from the aircraft owner device based on the identifying;
the processing device configured for:
analyzing the at least one aircraft owner data based on at least one aircraft owner regulation data, wherein the processing device is configured for generating at least one notification based on the analyzing of the at least one aircraft owner data; and
generating a result indication corresponding to the aircraft owner based on the analyzing of the at least one aircraft owner data; and
the storage device configured for retrieving the at least one aircraft owner regulation data from the database associated with the aviation service, wherein the at least one regulation data comprises the at least one aircraft owner regulation data.

14. The system of claim 11 further comprising:
the communication device configured for transmitting at least one eligibility indication to at least one of the instructor device and the aircraft owner device; and
the processing device configured for generating the at least one eligibility indication corresponding to at least of the instructor and the aircraft owner based on the analyzing of at least one of the at least one instructor data and the at least one aircraft owner data.

15. The system of claim 11 further comprising:
the communication device configured for:
transmitting at least one request to the instructor device based on the identifying;
receiving the at least one instructor data from the instructor device; and
transmitting at least one availability status data to the at least one student pilot device; and
the processing device configured for:
analyzing the at least one instructor data; and
generating the at least one availability status data corresponding to the aviation service based on the analyzing of the at least one instructor data.

16. The system of claim 11 further comprising:
the communication device configured for:
transmitting at least one request to the aircraft owner device based on the identifying;
receiving the at least one aircraft owner data from the aircraft owner device; and
transmitting at least one availability status data to the at least one student pilot device; and
the processing device configured for:
analyzing the at least one aircraft owner data; and
generating the at least one availability status data corresponding to the aviation service based on the analyzing of the at least one aircraft owner data.

17. The system of claim 11, wherein at least one of the instructor device and the aircraft owner device comprises at least one service sensor, wherein the system further comprising:
the communication device configured for:
receiving at least one service data from the at least one service sensor, wherein the at least one service sensor is configured for generating the at least one service data; and
transmitting the at least one service data to the at least one of the at least one student pilot device, the instructor device, and a regulatory authority device, wherein the regulatory authority device may be associated with a regulatory authority; and
the storage device is configured for storing the at least one service data in a database, wherein the storage device is communicatively coupled with the at least one service sensor.

18. The system of claim 11 further comprising:
the communication device configured for:
receiving at least one feedback from the at least one student pilot device, wherein the at least one feedback is associated with the aviation service; and
transmitting the at least one feedback to at least one of the at least one student pilot device, the instructor device, and the aircraft owner device; and
the storage device is configured for storing the at least one feedback.

19. The system of claim 11 further comprising:
the communication device configured for:
receiving at least one sensor data from the at least one of the instructor device and the aircraft owner device, wherein at least of the instructor device and the aircraft owner device comprises at least one student sensor, wherein the at least one student sensor is configured to generate the at least one sensor data, wherein the at least one sensor data is associated with the at least one student pilot and the instructor; and
transmitting, using the communication device, at least one alert to at least one of the at least one student pilot device, the instructor device, and the regulatory authority device; and
the processing device configured for:
analyzing the at least one sensor data based on the at least one regulation data; and
generating the at least one alert based on the analyzing of the at least one sensor data.

20. The system of claim 11, wherein at least one aircraft device is disposed on an aircraft, wherein the system further comprising:
the communication device configured for:
receiving at least one aircraft data from the at least one aircraft device, wherein the at least one aircraft device is configured to generate the at least one aircraft data, wherein each aircraft device of the at least one aircraft device is associated with each aircraft of at least one aircraft; and
transmitting each predetermined aircraft criterion and a score associated with the each aircraft of the at least one aircraft to the at least one student pilot device; and
the processing device configured for:
analyzing each aircraft data of the at least one aircraft data corresponding to the each aircraft based on at least one predetermined aircraft criterion; and
generating the score corresponding to the each predetermined aircraft criterion of the at least one predetermined aircraft criterion based on the analyzing of the each aircraft data.
